(19) United States
(12) Patent Application Publication
(10) Pub. No.: US 2025/0180770 A1
(43) Pub. Date: Jun. 5, 2025

(54) UTILIZING DRILLING DATA IN CONJUNCTION WITH A LEARNING MACHINE TO REALISTICALLY MAP GEOLOGY

(71) Applicant: Halliburton Energy Services, Inc., Houston, TX (US)

(72) Inventors: Jeremy James Combs, Houston, TX (US); David Franklin Anthony, Houston, TX (US); Edgar Gutierrez Gonzalez, Houston, TX (US)

(21) Appl. No.: 18/526,310

(22) Filed: Dec. 1, 2023

(51) Int. Cl. E21B 44/02; E21B 47/002

(52) U.S. Cl. CPC G01V 1/50; E21B 47/0025; E21B 44/02; G06T 2207/20081; G06T 2207/30181

(57) ABSTRACT

A computer-implemented method for drilling a wellbore in the Earth's subsurface. The computer-implemented method comprises obtaining one or more geological descriptions of one or more geological formations within the Earth's subsurface while drilling the wellbore. The computer-implemented method comprises generating, via a learning machine, respective images of the one or more geological formations based on one or more geological descriptions.

### TECHNICAL FIELD

This disclosure relation generally to the field of drilling a wellbore in a subsurface formation and more particular to the field of mapping the geology of a subsurface formation.

### BACKGROUND

In the drilling of a wellbore in subsurface formations, the geology of the target formation and surrounding formations may be mapped to visualize the various layers withing the Earth's subsurface. The mapping of the geological formations may be utilized when steering a drill bit through one or more of the geological formations such that a wellbore is positioned in a target zone.

### BRIEF DESCRIPTION OF THE DRAWINGS

Implementations of the disclosure may be better understood by referencing the accompanying drawings.

FIG. 1 is a schematic of an example well system, according to some implementations.

FIG. 2 is a flowchart depicting example operations for generating a realistic geology map, according to some implementations.

FIG. 3 is an illustration depicting an example realistic geology map, according to some implementations.

FIG. 4 is a flowchart depicting example operations to configure a learning machine, according to some implementations.

FIG. 5 is a flowchart depicting example operations to train a learning machine, according to some implementations.

FIG. 6 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. For instance, this disclosure refers to generating images of the geological formations while drilling a wellbore. Aspects of this disclosure can also be applied to any other periods in the process of drilling a wellbore. For clarity, some well-known instruction instances, protocols, structures, and operations have been omitted.

Example implementations related to mapping the geology of geological formations below the Earth's surface. The geological formations below the Earth's surface may have different features such as color, texture, grain size, etc. For example, a sandstone formation may have different features than a shale formation. The geological formations may also include anomalies such as natural fractures, faults, etc. A geological map of the geological formations that differentiate the layers of geological formations may be utilized while drilling a wellbore in one or more of the geological formations. For example, a geology map may be utilized to steer a drill bit through a target formation such that the drill bit does not penetrate the boundaries between the target formation and the surrounding geological formations. In some implementations, the features and/or anomalies may not be available for the current geological formations the wellbore is being drilled in. Thus, measurements of the target and/or surrounding geological formations may be obtained to assist in mapping the geological formations.

Conventional approaches may generate a geological map comprising a color smear based on the measurements, a resistivity profile, etc. For example, the different layers of geological formations of a conventional geological map may be represented by colors (i.e., does not include the features of the respective formations) based on the measurements obtained while drilling the wellbore and/or offset wellbore measurements. In some implementations, a realistic geology map that includes realistic images of the geological formations (i.e., images of the respective features and/or anomalies) may greatly improve the understanding of the respective formations and/or increase the desire to look at the image of the formations.

In some implementations, images of the respective geological formations may be generated, via a learning machine, based on one or more geological descriptions of the respective geological formations while drilling a wellbore in the Earth's subsurface. Geological descriptions may include measurements of the target formation and/or surrounding formations such as density, porosity, permeability, resistivity, etc. The measurements may be obtained from tools on the drilling assembly of the drill string and/or offset wellbore logs. The geological description may also include anomalies of the respective geological formation such as natural fractures, faults, hard streaks, etc. In some implementations, the geological descriptions of the respective geological formations may be input into a learning machine. The learning machine may be configured to accept a feature set that includes geological descriptions and trained to generate images of the respective geological formation. The images may include the features and/or anomalies of the geological formations. For example, the realistic image may include the color, grain size, natural fractures (if present) of a geological formation to represent what the geological formation may appear like in the Earth's subsurface. In some implementations, the realistic images may be actual images of the geological formation where the formation is exposed above the Earth's surface, such as in a cutout. In some implementations, the realistic image may be an image of a different geological formation but includes similar features, anomalies, etc. For example, the realistic image of a shale formation may not be an image of the actual shale formation being drilled, but may be a shale formation with a similar features and/or from a similar depositional environment.

In some implementations, the realistic images of the geological formations may be conjoined to generate a realistic geology map. The realistic geology map may include realistic images of the target formation being drilled and realistic images of the geological formations surrounding the target formations. In some implementations, the realistic geology map may be continuously updated, via the learning machine, as geological descriptions are obtained while the wellbore is drilled.

In some implementations, the realistic geology map may be used to perform a wellbore operations. For example, a wellbore operation may be initiated, modified, or stopped based on a realistic geology map. Examples of such downhole operations may include updating the planned well path of a wellbore, changing drilling operations, etc. For instance, the realistic geology map may indicate the location of a geological boundary between the target formation and a surrounding formation may be different than originally planned. Accordingly, wellbore operations may be adjusted such that the wellbore may remain in the target formation and not penetrate the boundary.

### Example System

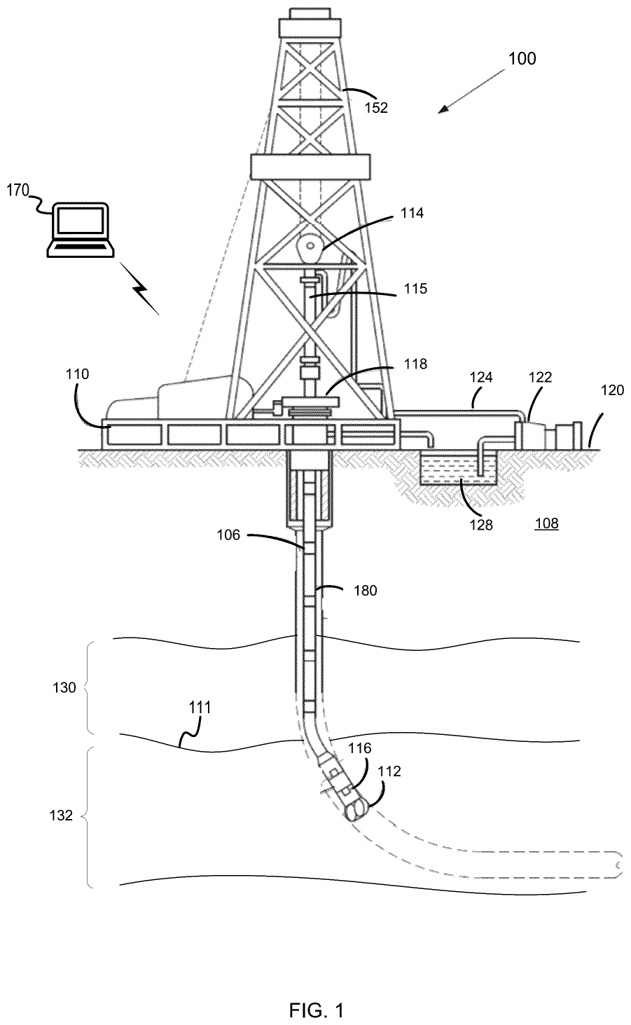

FIG. 1 is a schematic of an example well system, according to some implementations. In particular, FIG. 1 is a schematic diagram of a well system 100 that includes a drill string 180 having a drill bit 112 disposed in a wellbore 106 for drilling the wellbore 106 in the subsurface formation 108. While depicted for a land-based well system, example implementations may be used in subsea operations that employ floating or sea-based platforms and rigs.

The well system 100 may further include a drilling platform 110 that supports a derrick 152 having a traveling block 114 for raising and lowering the drill string 180. The drill string 180 may include, but is not limited to, drill pipe, drill collars, and drilling assembly 116. The drilling assembly 116 may comprise any of a number of different types of tools including a rotary steerable system (RSS), measurement while drilling (MWD) tools, logging while drilling (LWD) tools, mud motors, etc. A kelly 115 may support the drill string 180 as it may be lowered through a rotary table 118. The drill bit 112 may include roller cone bits, polycrystalline diamond compact (PDC) bits, natural diamond bits, any hole openers, reamers, coring bits, and the like. Drilling parameters of drilling the wellbore 106 may be adjusted to increase, decrease, and/or maintain the rate of penetration (ROP) of the drill bit 112 through the subsurface formation 108 and, additionally, steer the drill bit 112 through the subsurface formation 108. The subsurface formation 108 may include multiple geological formations such as geological formations 130, 132. The interface between the geological formations 130, 132 may be the formation bed boundary 111. The drilling parameters may assist in steering the wellbore 106 to avoid contact and/or penetration of the formation bed boundary 111. Drilling parameters may include weight-on-bit (WOB) and rotations-per-minute (RPM) of the drill string 180. A pump 122 may circulate drilling fluid through a feed pipe 124 to the kelly 116, downhole through interior of the drill string 180, through orifices in the drill bit 112, back to the surface 120 via an annulus surrounding the drill string 180, and into a retention pit 128.

In some implementations, various sections of the wellbore 106 such as the vertical, tangent, curve, and horizontal section may require directional drilling to steer the drill bit 112 on a planned well path and/or keep the wellbore 106 in a target formation. Sensors on the drilling assembly 116, such as gamma ray sensors, density sensors, porosity sensors, resistivity sensors, etc., may log respective measurements of the geological formations 130, 132 while drilling the wellbore 106. The measurement logs may be obtained from the sensors on the drilling assembly 116 and uplinked to the surface 120. In some implementations, the measurements may be communicated to tools on the drilling assembly 116 for processing. The measurements may be processed and utilized to determine characteristics of the geological formations 130, 132 such as features of the geological formations 130, 132, the location of the formation bed boundary 111, anomalies, fluid interfaces (such as an oil-water interface within a geological formation), etc. In some implementations, the wellbore operations may be determined based on the a realistic geology map of the geological formations 130, 132 and may be communicated back to the drilling assembly 116 for implementation to maintain the planned well path and/or remain in the target formation. For example, a target formation of the wellbore 106 may be geological formation 132. Steering decisions may be implemented such that the wellbore 106 may not be drilled through the formation bed boundary 111 and into geological formation 130.

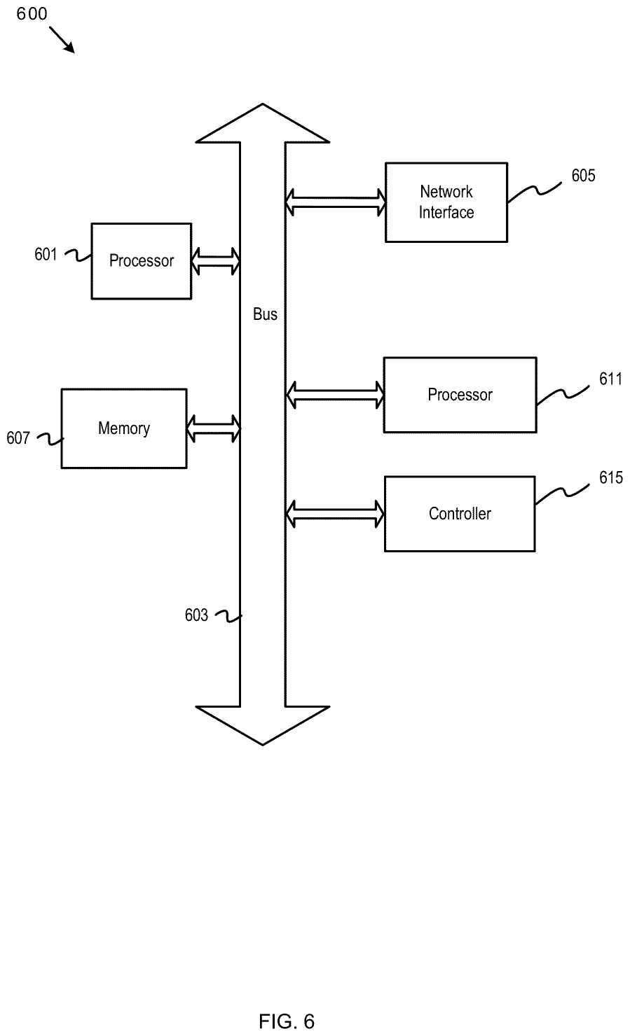

The well system 100 includes a computer 170 that may be communicatively coupled to other parts of the well system 100. The computer 170 may be local or remote to the drilling platform 110. A processor of the computer 170 may perform simulations (as further described below). In some implementations, the processor of the computer 170 may control drilling operations of the well system 100 or subsequent drilling operations of other wellbores. For instance, the processor of the computer 170 may generate realistic geology map of the geological formations 130, 132 based on the measurements obtained from the drilling assembly 116 and subsequently perform a wellbore operation based on the realistic geology map. An example of the computer 170 is depicted in FIG. 6, which is further described below.

### Example Operations

Examples operations are now described.

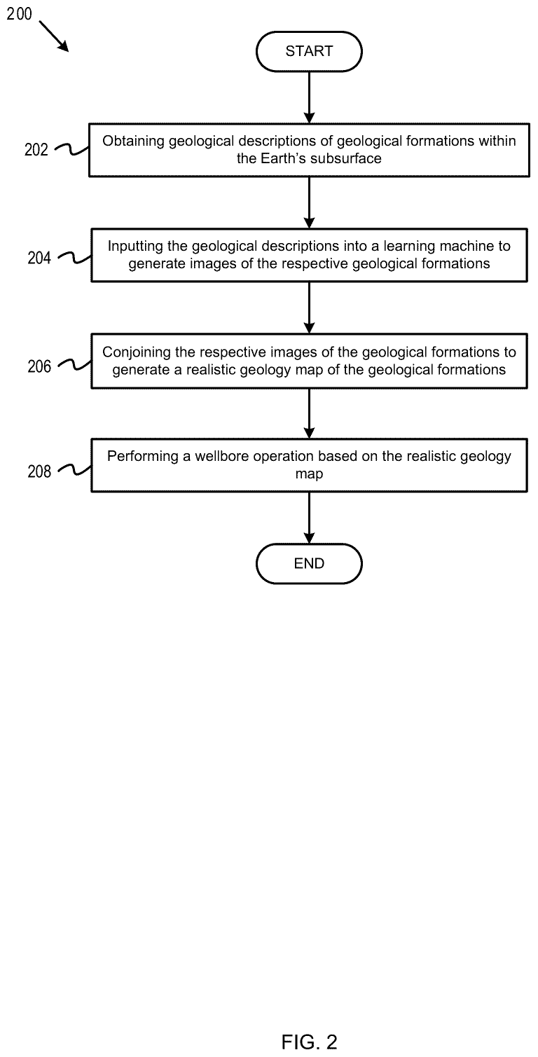

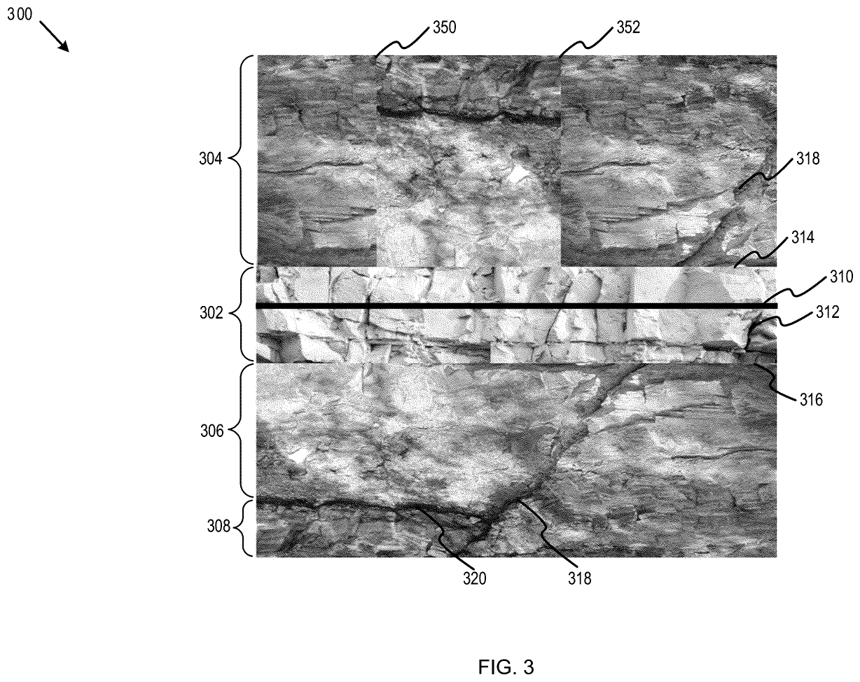

FIG. 2 is a flowchart depicting example operations for generating a realistic geology map, according to some implementations. FIG. 2 includes a flowchart 200 for generating realistic geology map with a learning machine. The learning machine may be any suitable artificial intelligence (AI) engine for generating images of geological formations. The flowchart 200 describes operations while drilling a wellbore in the Earth's subsurface. In some implementations, the operations of the flowchart 200 may be performed during and/or after a wellbore is drilled. Operations of flowchart 200 of FIG. 2 are described in reference to the processor of computer 170 of FIG. 1. Additionally, the operations of flowchart 300 are described in reference to FIG. 3. Operations of the flowchart 200 start at block 202.

At block 202, the processor of the computer 170 may obtain geological descriptions of the geological formations within the Earth's surface. The geological formations may include the target formation and/or formations in which the wellbore may be drilled in to ultimately produce. The geological formations may include the formations surrounding the target formation such as the geological formation above (i.e., at a shallower depth) and/or below (i.e., at a deeper depth) the target formation. The geological descriptions may include measurements of the geological formations such as density, porosity, resistivity, etc. The measurements may be obtained from tools positioned on the drilling assembly such as the logging-while-drilling (LWD) tool. Alternatively, or in addition to, the measurements may also be interpolated from offset wellbore logs. The measurements may determine properties of the rock itself (such as the rock density, rock porosity, etc.) and/or properties of the fluid within the rock (such as resistivity of the fluid within the pores of the rock). The geological descriptions may also include anomalies such as natural fractures, faults, boundaries, etc. In some implementations, the anomalies may be known prior to drilling the wellbore. For example, faults may be identified through seismic data, natural fractures may be known based on core sampling and/or formation sections exposed above the Earth's surface (i.e., cutouts), etc. In some implementations, the anomalies may be determined based on the measurements obtained while drilling. For example, the location of a formation boundary may be identified by differing resistivity profiles, density measurements, porosity measurements, etc. between the two formations.

In some implementations, the geological descriptions may include features of the respective geological formation. Features may include color, grain size, etc. Features may be determined by examining the actual formation rock such as through core samples, cutouts, etc. Features may also be determined via cutting samples obtained while drilling the wellbore.

In some implementations, the geological descriptions may be estimated prior to drilling the wellbore. For example, a well path positioned in a target formation may be planned prior to drilling the wellbore and/or planned ahead of the drill bit while drilling the wellbore. Accordingly, geological descriptions such as features, anomalies, measurements, etc. in the target formation and the surrounding formations may be estimated utilizing known data such as images of formation cutouts, seismic data, offset well logs, etc. The geological descriptions may be continuously updated as data is obtained (i.e., measurements) while the wellbore is drilled.

At block 204, the processor of the computer 170 may input the geological descriptions into a learning machine to generate images of the respective geological formations. The geological descriptions may correspond to each geological formation. For example, a subset of the geological descriptions may correspond to the target formation and another subset may correspond to the surrounding formations. In some implementations, the geological descriptions for respective geological formations may be similar and/or different. For example, resistivity measurements may be available for both the target formation and the surrounding formations due to a higher depth of investigation (DOI) of a resistivity sensor than other sensors on the drilling assembly, but the porosity measurements may only be available for the target formation. In some implementations, only a portion of the geological descriptions may be input into the learning machine. For example, only porosity and density measurements may be input into the learning machine, geological descriptions for a depth interval may be input into the learning machine, geological descriptions for only the target formation may be input into the learning machine, etc.

The images of the respective geological formation may be realistic images depicting features (such as color, texture, etc.), anomalies, or any other suitable visible properties. In some implementations, the images may include events such as water coning, mineralization, etc. The images may be for a portion of the respective geological formation such as a 1 foot depth interval, 100 foot depth interval, etc.

The images may be images of the actual geological formation. The images may represent how the geological formations may appear in the Earth's subsurface. The images may be from a portion of the formation that is exposed above the Earth's surface, such as in a cutout, and/or from any other suitable source depicting the formation (such as core samples). For example, a target formation of a wellbore may be the Fayetteville shale. A portion of the Fayetteville shale may be exposed above the Earth's surface where images of the formation may be captured. The images may include anomalies such as natural fracturing, faults, hard streaks etc. In some implementations, the images of a geological formation may be from a different formation but with similar features, anomalies, depositional environment, etc. For example, a target formation may be shale with natural fracturing. The images for the respective formation may be an image of a different shale formation but may depict similar color, texture, and natural fracturing to depict how the shale formation may appear in the Earth's subsurface.

In some implementations, the images may be generated prior to drilling the wellbore. When a well path is planned prior to drilling operations, the images may be generated based on the estimated geological descriptions. As the wellbore is drilled, the learning machine may update the images when geological descriptions are obtained via measurements from the drilling assembly, cuttings, etc.

At block 206, the processor of the computer 170 may conjoin the respective images of the geological formations to generate a realistic geology may of the geological formations. The geology map may include the target formation and/or surrounding formations.

To help illustrate, FIG. 3 is an illustration depicting an example realistic geology map, according to some implementations. FIG. 3 includes a realistic geology map 300 of a target formation 302 and surrounding formations 304, 306, and 308. A wellbore 310 is positioned in the target formation 302. A formation boundary 314 is the interface between the target formation 302 and surrounding formation 304. A formation boundary 316 is the interface between the target formation 302 and surrounding formation 306. The surrounding formation 306 and surrounding formation 308 are separated by the formation boundary 320. The formation boundaries 314, 316, and 320 may be identified by the learning machine and/or may be previously known. The target formation 302 includes a realistic image generated by the learning machine based on the geological descriptions of the target formation 302. As shown, the image of the target formation 302 includes texture of the rock and anomalies such as fractures 312. The surrounding formation 304 includes realistic images of the respective formation based on the respective geological descriptions. The images of the surrounding formation 304 may be multiple images to capture the varying features, anomalies, etc. at different intervals. For example, the surrounding formation 304 includes multiple images to capture the fault 318.

In some implementations, when there are multiple images of a geological formation, such as in the images of the surrounding formation 304, the images may be merged to smooth the transition between images, such as at interfaces 350, 352. Any suitable method may be utilized to smooth the interface between the images. For example, the color of the pixels for each image along interface 350, 352 may be adjusted to the average color of the 2, 10, etc. of the surrounding pixels to smooth the image interface 350, 352.

At block 208, the processor of the computer 170 may perform a wellbore operation based on the realistic geology map. For example, with reference to FIG. 3, drilling parameters may be adjusted to maintain a wellbore trajectory within the target formation 302 and avoid penetrating the formation boundaries 314, 316.

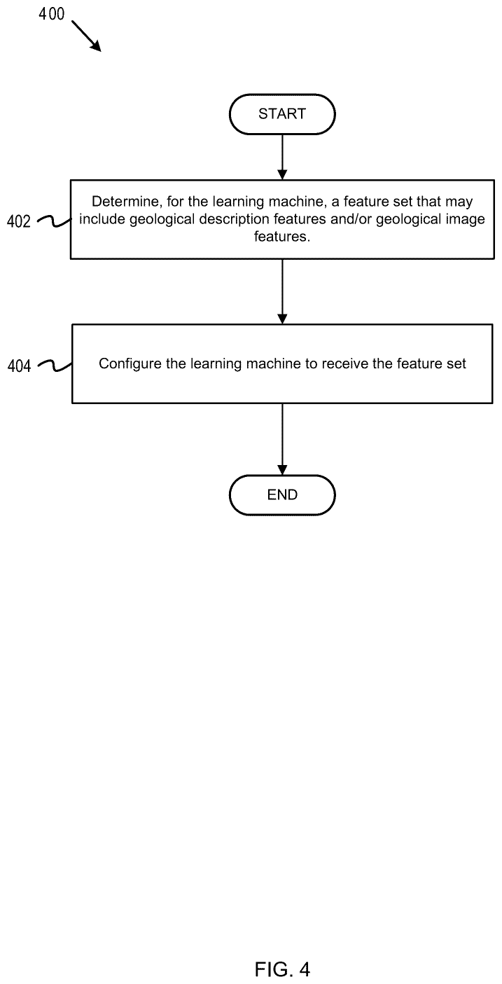

FIG. 4 is a flowchart depicting example operations to configure a learning machine, according to some implementations. FIG. 4 includes a flowchart 400 that may determine a feature set, and may configure the learning machine to receive the feature set as input. Operations of flowchart 400 of FIG. 4 are described in reference to the processor of the computer 170 of FIG. 1. Operations of the flowchart 400 start at block 402.

At block 402, the processor of the computer 170 may determine, for the learning machine, a feature set that may include geological description features and/or geological image features. A geological description feature may include features associated with the geological descriptions of geological formations such as measurements, anomalies, etc. A geological image feature may include features associated with realistic images of the geological formations. Some implementations may utilize any suitable feature set including any suitable value related to the realistic images of the geological formations.

At block 404, the processor of the computer 170 may configure the learning machine to receive the feature set as input. As noted, the features may include a geological description feature and/or a geological image feature. The flowchart 1100 ends after block 1104.

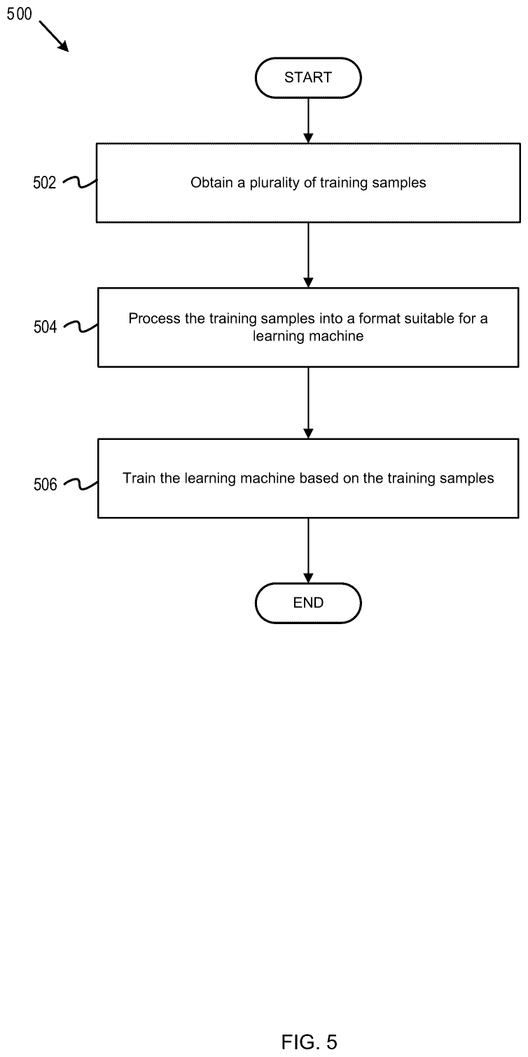

After block 404, the learning machine may begin training itself based on training samples. The discussion of FIG. 5 provides additional details about training samples and training the learning machine.

FIG. 5 is a flowchart depicting example operations to train a learning machine, according to some implementations. FIG. 5 includes a flowchart 500 that may train a supervised and/or unsupervised learning machine with training samples. Operations of flowchart 500 of FIG. 5 are described in reference to the processor of the computer 170 of FIG. 1. Operations of the flowchart 500 start at block 502.

At block 502, the processor of the computer 170 may obtain a plurality of training samples. Each training sample may be associated with a geological formation and/or a depositional environment. The training samples may include a geological description sample and a geological image sample. The a geological description sample and a geological image sample may be labeled with the geological formation name, formation features, anomalies, depositional environment, etc. For example, an image of a cutout of a geological formation may be obtained. Geological descriptions of that specific geological formation may be obtained (such as through lab testing of samples, visual analysis of the cutout, etc.). The geological description data may be utilized as a geological description sample and the image may be utilized as a geological image sample for training the learning machine, where each of the samples may be labeled with the formation name and/or depositional environment. The training samples may be generated by software and systems based on the system level design, numerical modeling, sample measurements, etc. For example, synthetic data may be generated and may be the labeled with formation name, depositional environment, anomalies, etc. to generate training samples. Some implementations may utilize any suitable technique to obtain training samples.

At block 504, the processor of the computer 170 may process the training samples into a format suitable for a learning machine. For instance, if the learning machine is configured to accept inputs with values between 0 and 1, the geological description sample may be scaled to values that between 0 and 1.

At block 506, the processor of the computer 170 may train the learning machine based on the training samples. The learning machine may use fewer than all the training samples in its training process. For example, the learning machine may utilize 80% of the training samples at block 504. Later, the learning machine may use the remaining 20% of the training samples to test the learning machine. The learning machine may be updated (i.e., trained) as new training samples are obtained. For instance, the learning machine be trained with updated training samples obtained from synthetic data, seismic interpretation, well log data, etc.

While the aspects of the disclosure are described with reference to various implementations and exploitations, it will be understood that these aspects are illustrative and that the scope of the claims is not limited to them. In general, techniques for generating realistic geology maps as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Computer

FIG. 6 is a block diagram depicting an example computer, according to some implementations. FIG. 6 depicts a computer 600 for classification of system tracts. The computer 600 includes a processor 601 (possibly including multiple processors, multiple cores, multiple nodes, and/or implementing multi-threading, etc.). The computer 600 includes memory 607. The memory 607 may be system memory or any one or more of the above already described possible realizations of machine-readable media. The computer 600 also includes a bus 603 and a network interface 605. The computer 600 can communicate via transmissions to and/or from remote devices via the network interface 605 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 600 also includes a processor 611 and a controller 615 which may perform the operations described herein. For example, the processor 611 may generate images of geological formations based on respective geological descriptions and generate a realistic geology map utilizing the images. The controller 615 may perform a wellbore operation based on the realistic geology map. The processor 611 and the controller 615 can be in communication. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Example Implementations

Implementation #1: A computer-implemented method for drilling a wellbore in the Earth's subsurface, the computer-implemented method comprising: obtaining one or more geological descriptions of one or more geological formations within the Earth's subsurface while drilling the wellbore; generating, via a learning machine, respective images of the one or more geological formations based on one or more geological descriptions.

Implementation #2: The computer-implemented method of Implementation #1, wherein the one or more geological descriptions include measurements of the one or more geological formations obtained from respective tools of a drilling assembly, the measurements including density, porosity, and resistivity.

Implementation #3: The computer-implemented method of Implementation #1 or #2, wherein the one or more geological descriptions include anomalies in the one or more geological formations, the anomalies including fractures and faults.

Implementation #4: The computer-implemented method of any one or more of Implementation #1-3, wherein the respective images of the one or more geological formations include realistic images depicting one or more geological features and anomalies, wherein the one or more geological features include color and texture.

Implementation #5: The computer-implemented method of any one or more of Implementation #4, wherein the respective images are actual images of the one or more geological formations or images of a similar geological formations with similar geological features and anomalies.

Implementation #6: The computer-implemented method of any one or more of Implementation #1-5 further comprising: determining a well path of the wellbore to be formed in the Earth's subsurface prior to drilling the wellbore; estimating the one or more geological descriptions of the one or more geological formations; generating respective images of the one or more geological formations based on the one or more geological descriptions; and updating the respective images as the geological descriptions are obtained while drilling the wellbore.

Implementation #7: The computer-implemented method of any one or more of Implementation #1-6 further comprising: determining, for the learning machine, a feature set including a geological description feature and a geological image feature; and configuring the learning machine to receive the feature set as input.

Implementation #8: The computer-implemented method of Implementation #7 further comprising: training the learning machine to generate images of the geological formations based on a plurality of training samples, the training samples including geological description samples and geological image samples.

Implementation #9: The computer-implemented method of any one or more of Implementation #1-8 further comprising: performing a wellbore operation based on the images.

Implementation #10: A non-transitory, computer-readable medium having instructions stored thereon that are executable by a processor to perform operations comprising: obtaining one or more geological descriptions of one or more geological formations within the Earth's subsurface while drilling a wellbore in the Earth's subsurface; generating, via a learning machine, respective images of the one or more geological formations based on one or more geological descriptions.

Implementation #11: The non-transitory, computer-readable medium of Implementation #10, wherein the one or more geological descriptions include measurements of the one or more geological formations obtained from respective tools of a drilling assembly, the measurements including density, porosity, and resistivity.

Implementation #12: The non-transitory, computer-readable medium of Implementation #10 or #11, wherein the one or more geological descriptions include anomalies in the one or more geological formations, the anomalies including fractures and faults.

Implementation #13: The non-transitory, computer-readable medium of any one or more of Implementation #10-12, wherein the respective images of the one or more geological formations include realistic images depicting one or more geological features and anomalies, wherein the one or more geological features include color and texture.

Implementation #14: The non-transitory, computer-readable medium of Implementation #13, wherein the respective images are actual images of the one or more geological formations or images of a similar geological formations with similar geological features and anomalies.

Implementation #15: The non-transitory, computer-readable medium of any one or more of Implementation #10-14 further comprising: determining, for the learning machine, a feature set including a geological description feature and a geological image feature; and configuring the learning machine to receive the feature set as input.

Implementation #16: The non-transitory, computer-readable medium of Implementation #15 further comprising: training the learning machine to generate images of the geological formations based on a plurality of training samples, the training samples including geological description samples and geological image samples.

Implementation #17: A system comprising: a processor; and a computer-readable medium having instructions stored thereon that are executable by the processor to cause the processor to, obtain one or more geological descriptions of one or more geological formations within the Earth's subsurface while drilling a wellbore in the Earth's subsurface; generate, via a learning machine, respective images of the one or more geological formations based on one or more geological descriptions.

Implementation #18: The system of Implementation #17, wherein the one or more geological descriptions include measurements of the one or more geological formations obtained from respective tools of a drilling assembly, the measurements including density, porosity, and resistivity.

Implementation #19: The system of Implementation #17 or #18, wherein the one or more geological descriptions include anomalies in the one or more geological formations, the anomalies including fractures and faults.

Implementation #20: The system of any one or more of Implementation #17-19, wherein the respective images of the one or more geological formations include realistic images depicting one or more geological features and anomalies, wherein the one or more geological features include color and texture.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A computer-implemented method for drilling a wellbore in the Earth's subsurface, the computer-implemented method comprising:
obtaining one or more geological descriptions of one or more geological formations within the Earth's subsurface while drilling the wellbore;
generating, via a learning machine, respective images of the one or more geological formations based on one or more geological descriptions.

2. The computer-implemented method of claim 1, wherein the one or more geological descriptions include measurements of the one or more geological formations obtained from respective tools of a drilling assembly, the measurements including density, porosity, and resistivity.

3. The computer-implemented method of claim 1, wherein the one or more geological descriptions include anomalies in the one or more geological formations, the anomalies including fractures and faults.

4. The computer-implemented method of claim 1, wherein the respective images of the one or more geological formations include realistic images depicting one or more geological features and anomalies, wherein the one or more geological features include color and texture.

5. The computer-implemented method of claim 4, wherein the respective images are actual images of the one or more geological formations or images of a similar geological formations with similar geological features and anomalies.

6. The computer-implemented method of claim 1 further comprising:
determining a well path of the wellbore to be formed in the Earth's subsurface prior to drilling the wellbore;
estimating the one or more geological descriptions of the one or more geological formations;
generating respective images of the one or more geological formations based on the one or more geological descriptions; and
updating the respective images as the geological descriptions are obtained while drilling the wellbore.

7. The computer-implemented method of claim 1 further comprising:
determining, for the learning machine, a feature set including a geological description feature and a geological image feature; and
configuring the learning machine to receive the feature set as input.

8. The computer-implemented method of claim 7 further comprising:
training the learning machine to generate images of the geological formations based on a plurality of training samples, the training samples including geological description samples and geological image samples.

9. The computer-implemented method of claim 1 further comprising:
performing a wellbore operation based on the images.

10. A non-transitory, computer-readable medium having instructions stored thereon that are executable by a processor to perform operations comprising:
obtaining one or more geological descriptions of one or more geological formations within the Earth's subsurface while drilling a wellbore in the Earth's subsurface;
generating, via a learning machine, respective images of the one or more geological formations based on one or more geological descriptions.

11. The non-transitory, computer-readable medium of claim 10, wherein the one or more geological descriptions include measurements of the one or more geological formations obtained from respective tools of a drilling assembly, the measurements including density, porosity, and resistivity.

12. The non-transitory, computer-readable medium of claim 10, wherein the one or more geological descriptions include anomalies in the one or more geological formations, the anomalies including fractures and faults.

13. The non-transitory, computer-readable medium of claim 10, wherein the respective images of the one or more geological formations include realistic images depicting one or more geological features and anomalies, wherein the one or more geological features include color and texture.

14. The non-transitory, computer-readable medium of claim 13, wherein the respective images are actual images of the one or more geological formations or images of a similar geological formations with similar geological features and anomalies.

15. The non-transitory, computer-readable medium of claim 10 further comprising:
determining, for the learning machine, a feature set including a geological description feature and a geological image feature; and
configuring the learning machine to receive the feature set as input.

16. The non-transitory, computer-readable medium of claim 15 further comprising:
training the learning machine to generate images of the geological formations based on a plurality of training samples, the training samples including geological description samples and geological image samples.

17. A system comprising:
a processor; and
a computer-readable medium having instructions stored thereon that are executable by the processor to cause the processor to,
obtain one or more geological descriptions of one or more geological formations within the Earth's subsurface while drilling a wellbore in the Earth's subsurface;
generate, via a learning machine, respective images of the one or more geological formations based on one or more geological descriptions.

18. The system of claim 17, wherein the one or more geological descriptions include measurements of the one or more geological formations obtained from respective tools of a drilling assembly, the measurements including density, porosity, and resistivity.

19. The system of claim 17, wherein the one or more geological descriptions include anomalies in the one or more geological formations, the anomalies including fractures and faults.

20. The system of claim 17, wherein the respective images of the one or more geological formations include realistic images depicting one or more geological features and anomalies, wherein the one or more geological features include color and texture.
